(19) United States
(12) Patent Application Publication
(10) Pub. No.: US 2024/0338242 A1
(43) Pub. Date: Oct. 10, 2024

(54) METHOD OF IMPROVING PROCESSING SPEED OF TRANSACTION IN BLOCKCHAIN NETWORK

(71) Applicant: ARTIFRIENDS INC., Gyeonggi-do (KR)

(72) Inventor: Jung Woo LEE, Daejeon (KR)

(73) Assignee: ARTIFRIENDS INC,, Seongnam-si, Gyeonggi-do (KR)

(21) Appl. No.: 18/575,122

(22) PCT Filed: Jun. 29, 2022
(86) PCT No.: PCT/KR2022/009273

§ 371 Date: Dec. 28, 2023

(30) Foreign Application Priority Data
Jun. 30, 2021 (KR) 10-2021-0085986
Jun. 27, 2022 (KR) 10-2022-0077996

(51) Int. Cl. G06F 9/46

(52) U.S. Cl. CPC G06F 9/466

(57) ABSTRACT

A method of improving a processing speed of a transaction in a blockchain network includes steps of loading data necessary for transaction processing in a bundle in advance onto the blockchain network according to a type of transaction presented by a client before execution of a smart contract, storing data to be stored in a bundle in the blockchain network according to a type of transaction to be processed after execution of the smart contract on the data loaded in the bundle, and performing bundled processing in units of blocks on the stored data without individually processing the transaction to be processed.

### TECHNICAL FIELD

The present invention relates to a method of improving a processing speed of a transaction in a blockchain network, and more particularly to a method of improving a processing speed of a transaction in a blockchain network capable of further improving a processing speed of a transaction by constructing middleware having means to solve a problem of existing middleware.

### BACKGROUND ART

In general, middleware is a generic term for software that connects different types of hardware, protocols, communication environments, etc. in a distributed computing environment to ensure smooth communication between an application program and an environment in which the program operates.

This middleware concept is equally applied to a blockchain, and becomes a solution to a problem that arises when general companies not possessing blockchain technology desire to introduce blockchain technology and has difficulties due to introduction of blockchain technology having a different development environment from that of an existing system possessed by the companies, that is, a legacy system.

For example, an alternative to solve the oracle problem of blockchain is introduction of middleware. The oracle problem is a problem that occurs when data from outside the blockchain is imported into the blockchain. To solve this problem, middleware is prepared to be able to provide reliable data between two systems.

In general, middleware may solve the oracle problem mentioned earlier when an organization or software capable of performing a role collects important data such as weather data and financial data and systematically provides this information through an API (Application Programming Interface).

Here, among several products introduced as blockchain middleware, “Provable” (formerly Oraclize) and “Chainlink” will be examined.

FIG. 1 is a diagram illustrating an overview of an operation of Provable, which is an oracle service in conventional blockchain middleware.

Referring to FIG. 1, Provable (formerly Oraclize) 110 is middleware used to solve the Oracle problem, and is an oracle service that collects various data from the real world and provides the data using an API method to a blockchain network desiring to operate a smart contract. Examples of a blockchain corresponding to Provable 110 include Ethereum 120 which is a distributed computing platform constructed based on Bitcoin and used to implement a smart contract function, Rootstock;rsk (130) which is a cryptocurrency created to address the high fees of Bitcoin and add the smart contract function of Ethereum, EOS 140 which is a third-generation cryptocurrency developed based on Ethereum using a delegated proof-of-stake (DpoS) method, Corda 150 which is a distributed ledger technology created by R3, the world's largest blockchain consortium, etc. A Web API 160 is an interface created to provide data stored in Provable 110 to the real world in http protocol.

Data of Provable 110 is provided separately in five types of URL in “http” protocol, Wolfram Alpha search engine, IPFS (InterPlanetary File System) which is a distributed file system, randomly generated values, and values produced through calculation, and all of the above work has been performed by a single entity. Therefore, processing is relatively fast. However, there are problems in that errors easily occur when a server goes down and data is centralized.

FIG. 2 is a diagram illustrating an overview of an operation of Chainlink in conventional blockchain middleware.

Referring to FIG. 2, Chainlink (Chainlink Network) 230 is a blockchain middleware platform (network) and encrypted currency used to connect blockchain smart contracts to data, payments, APIs, etc. outside the blockchain. Such Chainlink 230 serves to assist various smart contracts that operate based on Ethereum in easily connecting with data in the real world. To achieve this goal, a framework is provided to developers of other blockchains, including Solidity (a contract-oriented programming language), to interact with any external API, thereby providing an environment that may serve as a bridge between the real world and blockchain on the Ethereum mainnet. However, Chainlink 230 has concerns that the organization (Chainlink development and operation organization) or software that acts as middleware will become a new form of centralization, which has a problem of running counter to decentralization that blockchain aims for. In FIG. 2, reference number 210 refers to various physical devices (hardware) and software that provide data in the real world, reference number 220 refers to an external adapter that provides customized information so that the information provided by each piece of hardware may be used by Chainlink 230 in API form, reference number 240 refers to an oracle contract as a smart contract to connect between Chainlink 230 and existing blockchains to connect real-world data to existing blockchains, and reference number 250 refers to a smart contract application and web service (Frontend) that uses each individual blockchain technology (Bitcoin, Ethereum, and Hyperledger).

Further, in the existing blockchain network environment, transactions are processed by loading and storing necessary data each time an individual transaction is processed, which led to a problem of slowing down transaction processing speed.

Meanwhile, Korean Patent Publication No. 10-2021-0011139 (Patent Document 1) discloses “a node device capable of improving transaction processing speed by propagating transactions before creating blocks in a blockchain network and an operation method thereof,” and the operation method of the node device is characterized in that, when a storage event occurs in a specific node device to store first transaction data in the blockchain network, the specific node device generates a first transaction including the first transaction data, and then the first transaction is sequentially propagated to the remaining node devices, thereby allowing each node device to update a ledger database thereof based on the first transaction, so that processing of the first transaction is completed preferentially in each node device, and then when processing of the first transaction is completed in each node device, a block including the first transaction is registered in the blockchain network through a predetermined anchor node device.

Patent Document 1 described above has an advantage in improving processing speed of transactions in the blockchain by allowing each node device to update a ledger database thereof based on the first transaction, so that processing of the first transaction is completed preferentially in each node device, and then when processing of the first transaction is completed in each node device, a block including the first transaction is registered in the blockchain network through a predetermined anchor node device. However, a series of processes, in which the specific node device generates a first transaction including the first transaction data, then the first transaction is sequentially propagated to the remaining node devices, each node device is allowed to update a ledger database thereof based on the first transaction, processing of the first transaction is completed preferentially in each node device, and then when processing of the first transaction is completed in each node device, a block including the first transaction is registered in the blockchain network through a predetermined anchor node device, is complicated. Further, this also poses a problem that failures may easily occur when a server goes down and data may be centralized.

### DISCLOSURE

### Technical Problem

The present invention has been created to improve the problems of the conventional art described above, and an object of the present invention is to provide a method of improving a processing speed of a transaction in a blockchain network capable of further improving a processing speed of a transaction by constructing middleware that supports bundled processing of data loading and storage in order to solve problems of existing middleware, such as occurrence of failure due to server downtime and centralization of data or software, and to improve a processing speed of a transaction.

### Technical Solution

To achieve the above object, a method of improving a processing speed of a transaction in a blockchain network according to the present invention is
a method of improving a processing speed of a transaction in a blockchain network by constructing middleware that supports bundled processing of data loading and storage, each step of the method being performed by a computer system in the blockchain network, the method including steps of
a) loading data necessary for transaction processing in a bundle in advance onto the blockchain network according to a type of transaction presented by a client before execution of a smart contract,
b) storing data to be stored in a bundle in the blockchain network according to a type of transaction to be processed after execution of the smart contract on the data loaded in the bundle, and
c) performing bundled processing in units of blocks on the stored data without individually processing the transaction to be processed.

Here, a type of data to be loaded may be specified in the contract.

In addition, a procedure for processing the transaction may be specified in the contract.

In addition, in the step a), the data loaded in a bundle in advance according to a type of transaction may include “Send,” which is a block-based data bundle of a transaction for transmission of an issued token.

In addition, in the step a), the data loaded in a bundle in advance according to a type of transaction may include “MintNFT,” which is a block-based data bundle of a transaction that creates a non-fungible token (NFT).

In addition, in the step a), the data loaded in a bundle in advance according to a type of transaction may include “Burn,” which is a block-based data bundle of a transaction for burn processing for use of an issued token.

In addition, in the step b), the data stored in a bundle according to a type of transaction may include “Send,” which is a block-based data bundle of a transaction for transmission of an issued token.

In addition, in the step b), the data stored in a bundle according to a type of transaction may include “MintNFT,” which is a block-based data bundle of a transaction that creates an NFT.

In addition, in the step b), the data stored in a bundle according to a type of transaction may include “Burn,” which is a block-based data bundle of a transaction for burn processing for use of an issued token.

In addition, in the step a), the data loaded in a bundle in advance according to a type of transaction may include at least one of “Send,” which is a block-based data bundle of a transaction for transmission of an issued token, “MintNFT,” which is a block-based data bundle of a transaction that creates an NFT, or “Burn,” which is a block-based data bundle of a transaction for burn processing for use of an issued token.

In addition, in the step b), the data stored in a bundle according to a type of transaction may include at least one of “Send,” which is a block-based data bundle of a transaction for transmission of an issued token, “MintNFT,” which is a block-based data bundle of a transaction that creates an NFT, or “Burn,” which is a block-based data bundle of a transaction for burn processing for use of an issued token.

### Advantageous Effects

According to the present invention, there is an advantage in that it is possible to solve problems of existing middleware, such as occurrence of failure due to server downtime and centralization of data or software, and to further improve a processing speed of a transaction by constructing middleware that supports bundled processing of data loading and storage in order to solve problems of existing middleware, such as occurrence of failure due to server downtime and centralization of data or software, and to improve a processing speed of a transaction.

### DESCRIPTION OF DRAWINGS

FIG. 1 is a diagram illustrating an overview of an operation of Provable, which is an oracle service in conventional blockchain middleware.

FIG. 2 is a diagram illustrating an overview of an operation of Chainlink in conventional blockchain middleware.

FIG. 3 is a flowchart illustrating an execution process of a method of improving a processing speed of a transaction in a blockchain network according to the present invention.

FIG. 4 is a diagram illustrating a middleware operation mechanism of SASEUL employed to implement the method of improving the processing speed of the transaction according to the present invention.

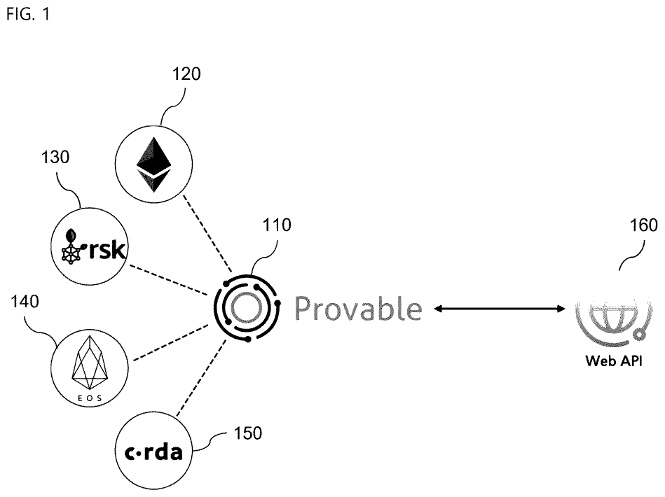

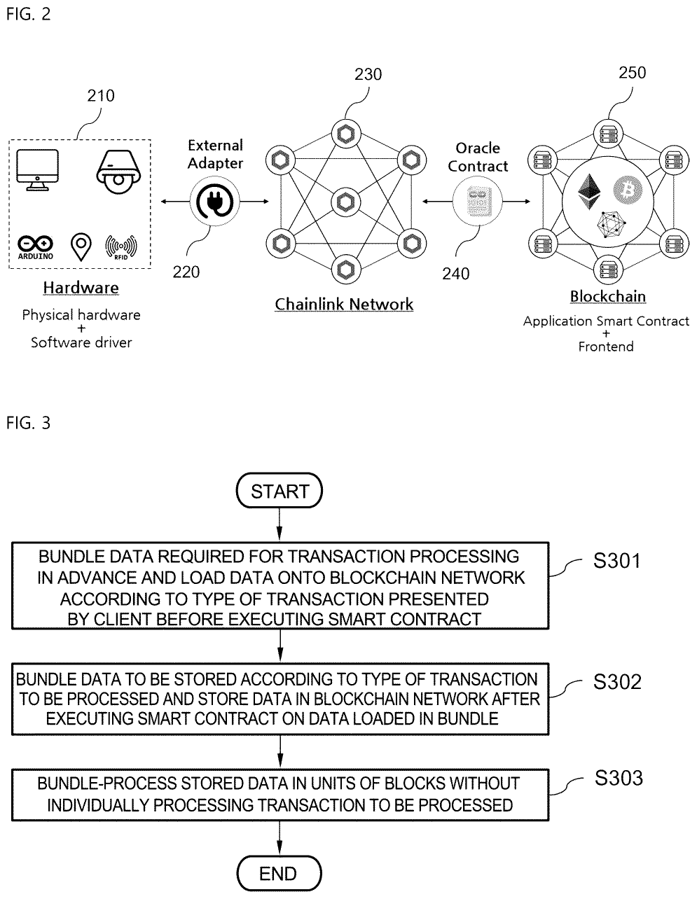

### MODE FOR INVENTION

Terms or words used in this specification and claims should not be construed as limited to ordinary or dictionary meanings, and should be interpreted as having meanings and concepts consistent with the technical idea of the present invention based on the principle that an inventor may appropriately define a concept of a term in order to describe the invention in the best way possible.

Throughout the specification, when a part “includes” a certain element, this means that another element may be further included rather than excluding another element unless specifically stated to the contrary. In addition, terms such as “ . . . unit,” “ . . . device,” “module,” and “device” used in the specification refer to a unit that processes at least one function or operation, which may be implemented as hardware, software, or a combination of hardware and software.

Hereinafter, embodiments of the present invention will be described in detail with reference to the attached drawings.

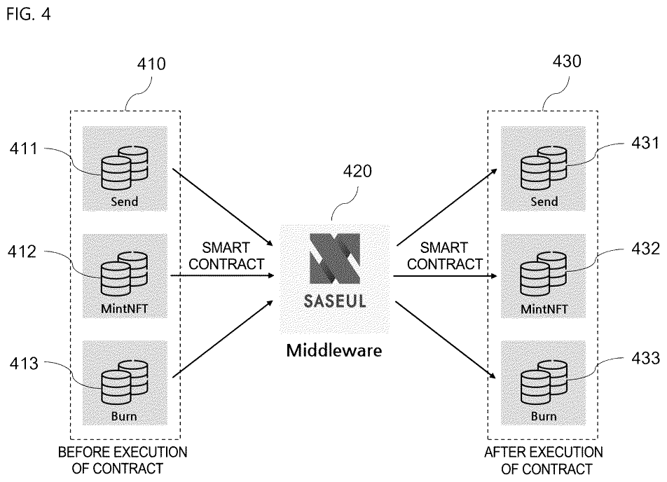

FIG. 3 is a flowchart illustrating an execution process of a method of improving a processing speed of a transaction in a blockchain network according to an embodiment the present invention, and FIG. 4 is a diagram illustrating a middleware operation mechanism of SASEUL employed to implement the method of improving the processing speed of the transaction according to the present invention.

Referring to FIGS. 3 and 4, each step of the method of improving the processing speed of the transaction in the blockchain network according to the present invention is performed by a computer system in the blockchain network. As a method of improving the processing speed of the transaction in the blockchain network through construction of middleware (for example, SASEUL middleware) 420 that supports bundled processing of data load and storage, first, before executing a smart contract, data required for transaction processing is loaded in a bundle onto the blockchain network in advance according to a type of transaction presented by a client (step S301). Here, a type of data to be loaded may be specified in the contract. In addition, procedures for processing the transaction may be specified in the contract. Here, data 410 loaded in a bundle in advance according to the type of transaction may include “Send” 411, which is a block-based data bundle of a transaction for transmission of an issued token.

In addition, the data 410, which is loaded in a bundle in advance according to the type of transaction, may include “MintNFT” 412, which is a block-based data bundle of a transaction that creates an NFT (Non-Fungible Token).

In addition, the data 410, which is loaded in a bundle in advance according to the type of transaction, may include “Burn” 413, which is a block-based data bundle of a transaction for burn processing for use of an issued token.

In addition, the data 410, which is loaded in a bundle in advance according to the type of transaction, may include at least one of “Send” 411, which is a block-based data bundle of a transaction for transmission of an issued token, “MintNFT” 412, which is a block-based data bundle of a transaction that creates an NFT (Non-Fungible Token), or “Burn” 413, which is a block-based data bundle of a transaction for burn processing for use of an issued token.

In other words, the data 410, which is loaded in a bundle in advance according to the type of transaction, may include any one of “Send” 411, “MintNFT” 412, and “Burn” 413, may include any two of “Send” 411, “MintNFT” 412, and “Burn” 413 (for example, “Send” 411 and “MintNFT” 412, or “MintNFT” 412 and “Burn” 413, or “Send” 411 and “Burn” 413), or may include all three of “Send” 411, “MintNFT” 412, and “Burn” 413.

In this way, when the data is loaded in a bundle in advance onto the blockchain network, a smart contract is executed by the SASEUL middleware 420 on the data loaded in the bundle, and then the data to be stored according to the type of transaction to be processed is bundled and stored in the blockchain network (step S302). Here, data 430 bundled and stored according to the type of transaction may include “Send” 431, which is a block-based data bundle of a transaction for transmission of an issued token, similar to the data 410 loaded in a bundle described above. Here, the SASEUL middleware 420 will be additionally described a little more.

The SASEUL middleware 420 is a software program (middleware) independently developed by the inventor of this application to improve transaction processing speed. Here, the name (expression) of chain (SASEUL) symbolically represents a shape in which blockchain networks are complexly intertwined like a chain, and such a name (expression) is frequently used in various services provided by the applicant (ARTIFRIENDS INC.) for business purposes.

In addition, the data 430 stored in a bundle according to the type of transaction may include “MintNFT” 432, which is a block-based data bundle of a transaction that creates a non-fungible token (NFT).

In addition, the data 430 stored in a bundle according to the type of transaction may include “Burn” 433, which is a block-based data bundle of a transaction for burn processing for use of an issued token.

In addition, the data 430 stored in a bundle according to the type of transaction may include at least one of “Send” 431, which is a block-based data bundle of a transaction for transmission of an issued token, “MintNFT” 432, which is a block-based data bundle of a transaction that creates a non-fungible token (NFT), or “Burn” 433, which is a block-based data bundle of a transaction for burn processing for use of an issued token.

In other words, as in the case of the data 410, which is loaded in a bundle according to the type of transaction, the data 430 stored in a bundle according to the type of transaction may include any one of “Send” 431, “MintNFT” 432, and “Burn” 433, may include any two of “Send” 431, “MintNFT” 432, and “Burn” 433 (for example, “Send” 431 and “MintNFT” 432, or “MintNFT” 432 and “Burn” 433, or “Send” 431 and “Burn” 433), or may include all three of “Send” 431, “MintNFT” 432, and “Burn” 433.

When the data to be stored according to the type of transaction is bundled and stored in the blockchain network as described above, the stored data is bundle-processed in units of blocks without individually processing the transaction to be processed (step S303).

Through the processing method of step S303 as described above, the method of the present invention may achieve relatively improved processing speed compared to the transaction processing speed in the existing blockchain network.

As described above, the method of improving a processing speed of a transaction in a blockchain network according to the present invention has an advantage in that it is possible to solve problems of existing middleware, such as occurrence of failure due to server downtime and centralization of data or software, and to further improve a processing speed of a transaction by constructing middleware that supports bundled processing of data loading and storage in order to solve problems of existing middleware, such as occurrence of failure due to server downtime and centralization of data or software, and to improve a processing speed of a transaction.

Even though the present invention has been described above in detail through preferred embodiments, the present invention is not limited thereto, and it is obvious to those skilled in the art that various changes and applications may be made without departing from the technical spirit of the present invention. Therefore, the true scope of protection of the present invention should be interpreted in accordance with the following claims, and all technical ideas within the equivalent scope should be interpreted as being included in the scope of rights of the present invention.

1. A method of improving a processing speed of a transaction in a blockchain network by constructing middleware that supports bundled processing of data loading and storage, each step of the method being performed by a computer system in the blockchain network, the method comprising steps of:
a) loading data necessary for transaction processing in a bundle in advance onto the blockchain network according to a type of transaction presented by a client before execution of a smart contract;
b) storing data to be stored in a bundle in the blockchain network according to a type of transaction to be processed after execution of the smart contract on the data loaded in the bundle; and
c) performing bundled processing in units of blocks on the stored data without individually processing the transaction to be processed.

2. The method according to claim 1, wherein a type of data to be loaded is specified in the contract.

3. The method according to claim 1, wherein a procedure for processing the transaction is specified in the contract.

4. The method according to claim 1, wherein, in the step a), the data loaded in a bundle in advance according to a type of transaction comprises “Send,” which is a block-based data bundle of a transaction for transmission of an issued token.

5. The method according to claim 1, wherein, in the step a), the data loaded in a bundle in advance according to a type of transaction comprises “MintNFT,” which is a block-based data bundle of a transaction that creates a non-fungible token (NFT).

6. The method according to claim 1, wherein, in the step a), the data loaded in a bundle in advance according to a type of transaction comprises “Burn,” which is a block-based data bundle of a transaction for burn processing for use of an issued token.

7. The method according to claim 1, wherein, in the step b), the data stored in a bundle according to a type of transaction comprises “Send,” which is a block-based data bundle of a transaction for transmission of an issued token.

8. The method according to claim 1, wherein, in the step b), the data stored in a bundle according to a type of transaction comprises “MintNFT,” which is a block-based data bundle of a transaction that creates an NFT.

9. The method according to claim 1, wherein, in the step b), the data stored in a bundle according to a type of transaction comprises “Burn,” which is a block-based data bundle of a transaction for burn processing for use of an issued token.

10. The method according to claim 1, wherein, in the step a), the data loaded in a bundle in advance according to a type of transaction comprises at least one of “Send,” which is a block-based data bundle of a transaction for transmission of an issued token, “MintNFT,” which is a block-based data bundle of a transaction that creates an NFT, or “Burn,” which is a block-based data bundle of a transaction for burn processing for use of an issued token.

11. The method according to claim 1, wherein, in the step b), the data stored in a bundle according to a type of transaction comprises at least one of “Send,” which is a block-based data bundle of a transaction for transmission of an issued token, “MintNFT,” which is a block-based data bundle of a transaction that creates an NFT, or “Burn,” which is a block-based data bundle of a transaction for burn processing for use of an issued token.
